(19) United States
(12) Patent Application Publication
(10) Pub. No.: US 2023/0385703 A1
(43) Pub. Date: Nov. 30, 2023

(54) HIGH-RESOLUTION ENVIRONMENTAL SENSOR IMPUTATION USING MACHINE LEARNING

(71) Applicant: Hippo Harvest Inc., San Francisco, CA (US)

(72) Inventors: Adam Riesselman, Pacifica, CA (US); Wim Meeussen, Redwood City, CA (US)

(73) Assignee: Hippo Harvest Inc., San Francisco, CA (US)

(21) Appl. No.: 18/325,742

(22) Filed: May 30, 2023

Related U.S. Application Data
(60) Provisional application No. 63/365,471, filed on May 27, 2022.

(51) Int. Cl. G06N 20/00; G05B 23/02

(52) U.S. Cl. CPC G06N 20/00; G05B 23/0224

(57) ABSTRACT

Systems and methods for high spatial and temporal resolution of environmental observations. Improved resolution is achieved by using machine learning methods to build a function from observations from frequently measuring stationary sensors to another sensor in a different location at a corresponding time. Given values from the reference sensor, the learned function can impute sensor measurements in unobserved locations and times.

### CROSS-REFERENCE TO RELATED APPLICATIONS

This application claims priority to Provisional U.S. Patent Application Ser. No. 63/365,471, titled “HIGH-RESOLUTION ENVIRONMENTAL SENSOR IMPUTATION USING MACHINE LEARNING,” (HPPOP008P) filed on May 27, 2022, by Adam Riesselman et al., which is incorporated herein by reference in its entirety and for all purposes.

### TECHNICAL FIELD

The present disclosure relates generally to agriculture, and more specifically to grow space systems.

### DESCRIPTION OF RELATED ART

Agriculture has been a staple for mankind, dating back to as early as 10,000 B.C. Through the centuries, farming has slowly but steadily evolved to become more efficient. Traditionally, farming occurred outdoors in soil. However, such traditional farming required vast amounts of space and results were often heavily dependent upon weather. With the introduction of greenhouses, crops became somewhat shielded from the outside elements, but crops grown in the ground still required a vast amount of space. In addition, ground farming required farmers to traverse the vast amount of space in order to provide care to all the crops. Further, when growing in soil, a farmer needs to be very experienced to know exactly how much water to feed the plant. Too much and the plant will be unable to access oxygen; too little and the plant will lose the ability to transport nutrients, which are typically moved into the roots while in solution.

Two of the most common errors when growing are overwatering and underwatering. With the introduction of hydroponics, the two most common errors are eliminated. Hydroponics prevents underwatering from occurring by making large amounts of water available to the plant. Hydroponics prevents overwatering by draining away, recirculating, or actively aerating any unused water, thus, eliminating anoxic conditions.

Operating a hydroponic grow space today comes with a number of challenges that places significant burdens on farmers and leads to increased costs and/or inefficient food production. For example, current hydroponic systems have high manual labor costs for maintenance of crops. If farmers want to reduce labor costs, they can purchase traditional manufacturing equipment, which is very expensive. One way to address these challenges is to increase efficiency of a grow space. In order to do that, one must understand the physical variables of an environment or grow space. Thus, there is a need for a way to more efficiently understand environmental conditions in a grow space.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

Aspects of the present disclosure relates to a system and a grow space. The system or grow space comprises a reference sensor, a query sensor, a processor, and memory. The memory stores instructions to cause a processor to execute a method. The method comprises training a machine learning model. The training includes obtaining a first set of measurements from the reference sensor. The training also includes obtaining a second set of measurements from the query sensor. The training also includes processing the first and second set of measurements to train a machine learning model. Last, the training includes training the machine learning model to build a map from the reference sensor to the query sensor. The method next comprises obtaining a third set of measurements from the reference sensor. The method then includes inputting the third set of measurements into the trained machine learning model. Last, the method includes outputting one or more predicted query sensor values.

Another aspect of the present disclosure relates to a method for predicting grow space sensor query sensor values using a machine learning model. The method includes training a machine learning model. The training includes obtaining a first set of measurements from a reference sensor. The training also includes obtaining a second set of measurements from a query sensor. The training also includes processing the first and second set of measurements to train a machine learning model. Last, the training includes training the machine learning model to build a map from the reference sensor to the query sensor. The method next comprises obtaining a third set of measurements from the reference sensor. The method then includes inputting the third set of measurements into the trained machine learning model. Last, the method includes outputting one or more predicted query sensor values.

In some embodiments, the second set of measurements from the query sensor is remotely acquired by a mechanical or robotic apparatus in an environment or grow space. In some embodiments, the predicted query sensor values are used to provide robustness and redundancy in the case of unreliable sensor measurements. In some embodiments, the predicted query sensor values are used to notify changes or disruptions in grow spaces and/or environmental control systems. In some embodiments, predicted query sensor values are used to control environmental control systems. In some embodiments, predicted query sensor values are used to explain variation in plant phenotypes. In some embodiments, the query sensor is a moving sensor configured to sense conditions around a grow space.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments.

FIG. 1A is a block diagram of using a machine learning model to predict query sensor values, in accordance with embodiments of the present disclosure.

FIG. 1B is a block diagram of using a machine learning model to predict moving sensor values, in accordance with embodiments of the present disclosure.

FIG. 2A shows an example of a robot measuring sensor values, in accordance with embodiments of the present disclosure.

FIG. 2B shows another example of a robot measuring sensor values, in accordance with embodiments of the present disclosure.

FIG. 3 is another block diagram of using a machine learning model to predict query sensor values, in accordance with embodiments of the present disclosure.

FIG. 4 illustrates an example method of data processing using machine learning, in accordance with embodiments of the present disclosure.

FIG. 5 illustrates an example grow space using query sensors, in accordance with embodiments of the present disclosure.

FIG. 6 is a block diagram showing how predicted moving sensor values can be used to adjust infrastructure control, in accordance with embodiments of the present disclosure.

FIG. 7 is a block diagram showing how predicted moving sensor values can be used to adjust different plant variables, in accordance with embodiments of the present disclosure.

FIG. 8 illustrates a method for predicting grow space sensor query sensor values using a machine learning model, in accordance with embodiments of the present disclosure.

FIG. 9 illustrates an example of a computer system, configured in accordance with one or more embodiments of the present disclosure.

### DESCRIPTION OF EXAMPLE EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, portions of the techniques of the present disclosure will be described in the context of particular hydroponic grow systems. However, it should be noted that the techniques of the present disclosure apply to a wide variety of different grow systems. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a growing tray in a variety of contexts. However, it will be appreciated that a system can use multiple growing trays while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, plant roots may be connected to nutrient water, but it will be appreciated that a variety of layers, such as grow mediums and buffer mats, may reside between the plant roots and nutrient water. Consequently, a connection does not necessarily mean a direct, unimpeded connection unless otherwise noted.

As mentioned above, one way to address the challenges of a grow space is to understand the physical variables of the environment in a grow space. Understanding the physical variables of an environment or space of interest is paramount to farming, as well as a number of different industries. Variables such as temperature, humidity, sound, light intensity, wind, and air composition can strongly influence or constrain utility of a physical space or structure. Environmental sensors can be used to observe these factors: for example, thermometers can measure temperature, anemometers can measure wind speed, hygrometers can measure humidity, etc. With typical deployment, these sensors observe and record environmental conditions at a fixed location at regular intervals over a period of time. Typically, a representative location is chosen to place a sensor, and environmental conditions are recorded at regular intervals. However, this procedure may fail to capture the variability in environmental conditions that actually occur over time across a region of interest.

To better understand the environmental conditions of a space, increased resolution is needed by obtaining more observations of the environment, both across the physical space as well as more frequently from a temporal perspective. Ideally, sensors would continue to be added until the desired resolution is achieved. However, this approach has a number of drawbacks. First, a space may be so large that adding an adequate number of sensors may be cost prohibitive. Second, certain sensor placements may not be possible due to the intrinsic location of the area of interest. Third, placement of a sensor may alter or affect processes performed in the space. Last, sensors may not be reliable or may drop out, leading to missing, inconsistent observations.

In an agricultural setting, sensing of environmental conditions is paramount to profitable husbandry. Frequent, high-resolution measurements of environmental variables are required for consistent, healthy plants and animals.

### EXAMPLE EMBODIMENTS

Understanding the physical environment of a space of interest is paramount to a number of industries. In an agricultural setting, the environment can have a strong impact on the health and productivity of plants and livestock. Environmental sensors observe and record changes to the physical environment in a given location at a given time. To increase the spatial resolution of observations, additional sensors can be deployed to record the physical environment in multiple locations. However, using multiple sensors can be cost prohibitive. Obtaining measurements of a physical location may even be limited by constraints of the space. Additionally, sensors can break and stop recording. Adding more sensors as a back-up can alleviate this issue, but at additional cost in both up-front capital for sensors and in ongoing maintenance of an expanded sensor network.

Due to the physical properties of the environment, the readings from multiple sensors at corresponding times are strongly correlated with one another. By making a number of observations across space and time, the correlation structure can be parameterized. Understanding this correlation structure allows for prediction of unknown sensor values from known sensor values at corresponding times. This technique both reduces hardware cost and increases observation resolution.

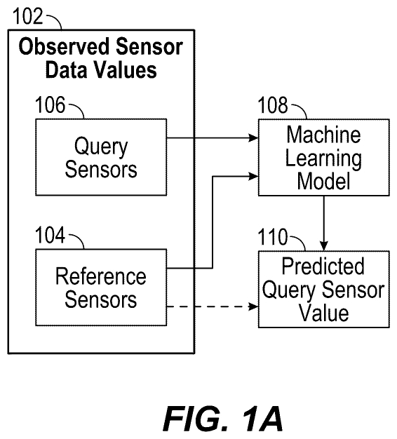

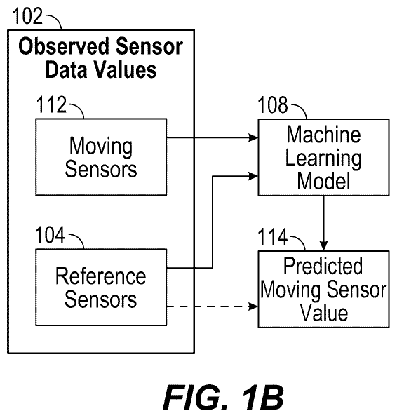

FIG. 1A is a block diagram of using a machine learning model to predict query sensor values, in accordance with embodiments of the present disclosure. The embodiment shown in FIG. 1A uses machine learning to build a function to capture and utilize the correlation structure between a set of observed sensor data values. Measurements 102 from two or more sensors are recorded over a corresponding period of time. Additional variables, such as the time and location of the sensors at the time of each observation, may also be recorded. A set of observations from reference sensors 104 and associated variables are used as input to a machine learning model 108 which is trained to predict an output of observations from query sensors 106. Observations used during training may come from either the same or different type of sensor. Given a trained machine learning model 108 and new reference sensor values 104, predicted values of the query sensors 110 can then be determined.

In some embodiments, high spatial resolution of sensor measurements of a physical space is very desirable. In some embodiments, allowing a single sensor to move around a physical space, such as through a robotic, boom, gantry, UAV, or manual system, can provide a desired spatial resolution. However, this process is time consuming and potentially expensive. Moreover, this process is difficult to perform frequently and at regular intervals, as the sampling procedure itself occupies the sensor's time. Stationary sensors do provide high temporal resolution at regular intervals, but at the expense of spatial resolution.

FIG. 1B is a block diagram of using a machine learning model to predict moving sensor values, in accordance with embodiments of the present disclosure. The embodiment shown in FIG. 1B uses a machine learning model to build a function from a stationary sensor to a moving sensor at a given location over a corresponding time. Sensor data values 102 are recorded from both moving sensors 112 and stationary reference sensors 104 over a corresponding amount of time. In addition, the location of any one of the moving sensor 112 is also recorded at the time the observation is taken. A machine learning model 108 is trained to predict the moving sensor value 114, conditioned on the stationary sensor value at a corresponding time and the location of the moving sensor. Once the model is trained, using the reference sensor values, new query sensor values 114 can be predicted at any given location. In practice, this provides high spatial and temporal resolution of sensor values at a greatly reduced hardware cost and sampling time.

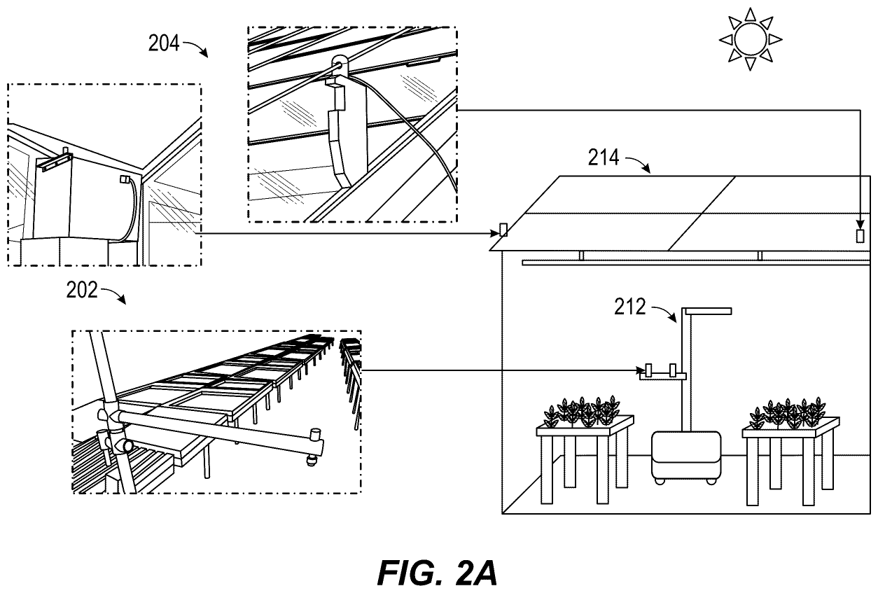

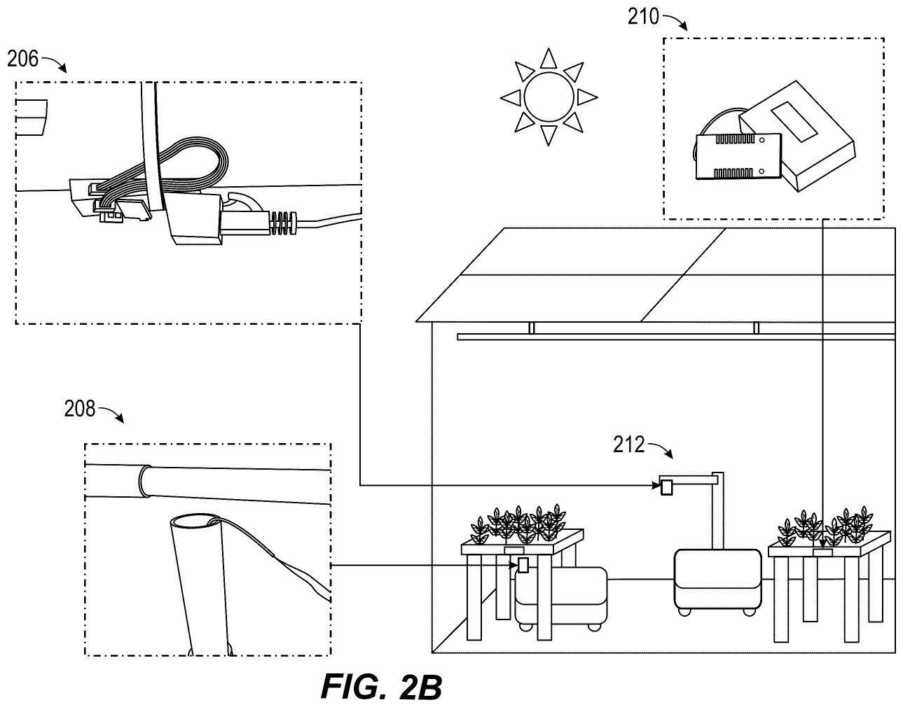

FIG. 2A shows an example of a robot measuring sensor values, in accordance with embodiments of the present disclosure. In one embodiment of the work in FIG. 2A, par meters 202, a special type of photometer, are placed on a robot 212 to measure light intensity at plant level across the entire physical space. In some embodiments, this robot is programmed to record this data over a defined space at a specific time, yielding high-spatial resolution, low frequency observations. In some embodiments, par meters 204 are also placed on the roof 214 of the grow space, yielding frequent light intensity observations with low spatial resolution. As described in FIG. 1B, the robot acts as moving sensors 112 and the outdoor par meters act as reference sensors 104. After a sufficient number of observations 102, a machine learning model 108 is trained as described previously. Given additional outdoor par meter values 104 and the trained machine learning model 108, light intensity values are predicted 114 at regular time intervals isotropically distributed across the physical space of interest.

FIG. 2B shows another example of a robot measuring sensor values, in accordance with embodiments of the present disclosure. In one embodiment of the work illustrated in FIG. 2B, infrared temperature sensors 206 and 208 are placed on a robot 212 to measure both canopy temperature 206 from above the plants, and module water temperature 208 from below the plants. In some embodiments, robot 212 is programmed to record this data over a defined space at a specific time, yielding high-spatial resolution, low frequency observations. In some embodiments, stationary temperature sensors 210 (e.g., thermometers) are placed around the physical space, yielding frequent temperature measurements with limited temperature resolution. As described in FIG. 1B, the sensors on robot 212 act as moving sensors 112 and the indoor thermometers 210 act as reference sensors 104. After a sufficient number of observations 102, a machine learning model 108 is trained as described previously. Given additional indoor temperature sensor values 104 and the trained machine learning model 108, module and canopy temperatures are predicted at regular time intervals 114 for areas occupied by plants in the grow space.

In the first example shown in FIG. 2A, the predicted and moving sensors are of the same type, i.e., they produce the same environmental reading. In the second example in FIG. 2B, each is a different type of sensor because the stationary sensors measure air temperature, while the moving sensors measure the temperature of surfaces.

According to various embodiments, reduction to practice of the described system on computational resources is nontrivial. For example, processing multiple sensor values to find corresponding times and handling missing values can be a time consuming process. The physical environment of interest can change over time, leading to a machine learning model that is only valid for a finite period of time. If this happens, the machine learning model may become biased or not able to accurately capture variability in the environment.

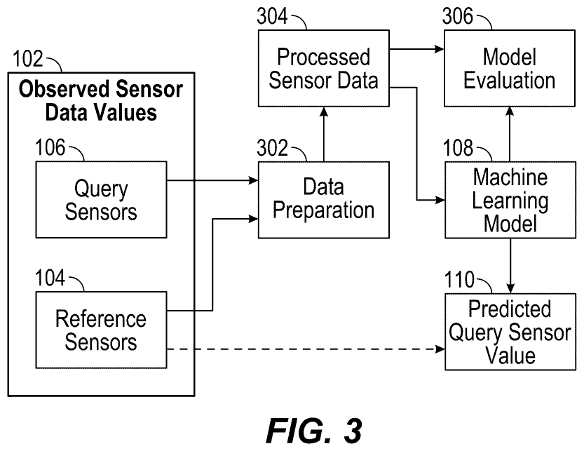

FIG. 3 is another block diagram of using a machine learning model to predict query sensor values, in accordance with embodiments of the present disclosure. As shown in FIG. 3, the workflow includes processes of automatically collecting and processing sensor data, performing model and data quality control, and selecting the appropriate model to predict sensor data values. As described previously, sensor data values 102 from query sensors 106 and reference sensors 104 are aggregated over some fixed period of time, e.g., a single day. The data is prepared 302 by finding corresponding times between those observations and by including additional variables useful for prediction, such as sensor location, sun angle location, and total elapsed time from the start of all observations. In some embodiments, sensor values can be interpolated such that the sensor values all represent the exact same time. However, alternative machine learning approaches exist in which this is not a requirement. In some embodiments, these processed sensor values are then deposited into a database 304. Processed data is then selected from this database to train a machine learning model 108, which builds a function from reference sensor values and additional variables to query sensor values. In some embodiments, the model artifact is then deposited into a database for later use.

In some embodiments, at a given time, an appropriate model is selected 306 from the database that most accurately reflects the condition of the physical space. Once the model is selected, it is used for quality control and predicting query sensor values 110. In some embodiments, the quality of the model is determined by predicting query sensor values and determining how they differ from previously observed query sensor values. In some embodiments, by measuring the difference between observed and expected values, this process can also detect unforeseen changes to grow space infrastructure.

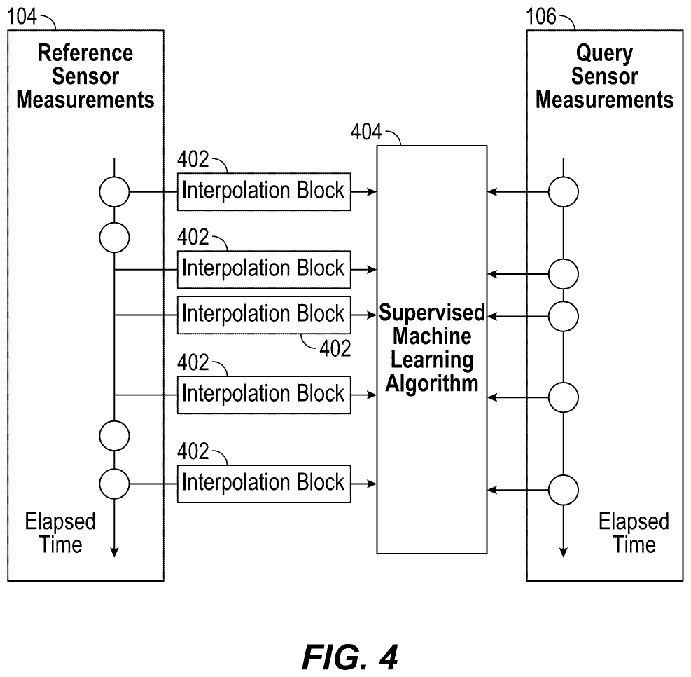

FIG. 4 illustrates an example method of data processing using machine learning, in accordance with embodiments of the present disclosure. In some embodiments, reference sensor measurements 104 and query sensor measurements 106 are typically taken at irregular intervals over a period of time. In some embodiments, first, sensor values must be matched between the two sensor measurements. In some embodiments, this is done using an interpolation block 402, where reference sensor values are transformed in such a way that they temporally correspond with query sensor measurements. In some embodiments, for each query sensor measurement timestamp, k-means interpolation creates reference sensor values at that exact time using temporally similar observed reference sensor values. In some embodiments, paired reference and query sensor measurements are then aggregated for training a supervised machine learning algorithm 404. There, the interpolated reference sensor values 104 and additional covariates, such as time, location, infrastructure controls, and sun angle features, regress to observed query sensor measurements 106. In some embodiments, the supervised machine learning model 404 can be any of the following algorithms: linear regression, kernel regression, support vector machines, decision trees, random forests, gradient boosted trees, k-means regression, and deep learning.

In some embodiments, having consistent sensor readings is important for reliable and robust observations of a physical environment. However, in some embodiments, sensors can break or stop reporting, causing a loss of values. In such embodiments, additional sensors can make redundant observations, but at an additional cost.

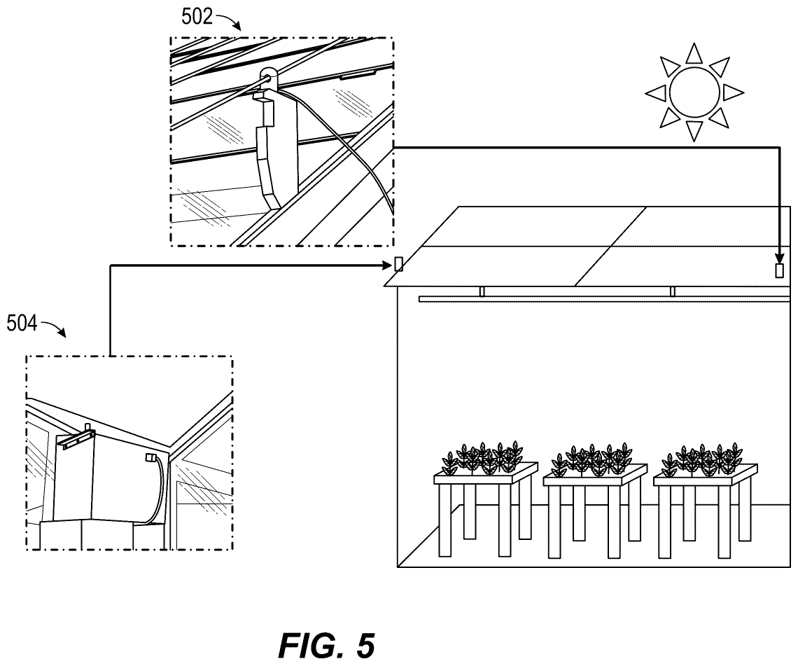

In some embodiments, a machine learning model can learn the correlation structure between two stationary sensor values. FIG. 5 illustrates an example grow space using query sensors, in accordance with embodiments of the present disclosure. FIG. 5 is a special case of FIG. 1A, where both the query sensor 106 and the reference sensor 104 have a constant physical location. In the example shown in FIG. 5, two stationary par sensors 502 and 504 are placed in two distinct physical locations in the grow space. Given light intensity observations from par meter 502 and additional variables, a machine learning model can be used to predict the light intensity values from par meter 504. In some embodiments, if the sensor values are not reported or are lost for 504, they can be predicted using the machine learning model and the values from sensor 502.

According to various embodiments, many different types of infrastructure can control the physical environment of a space, such as heaters, coolers, fans, shades, and artificial lighting. However, it can be difficult to know how to control these elements to influence the environment specifically for a given location at a given time. Typically, a single, stationary sensor is used to measure the impact of a piece of infrastructure and make adjustments, but it may not capture how the infrastructure affects the physical environment in sufficient resolution.

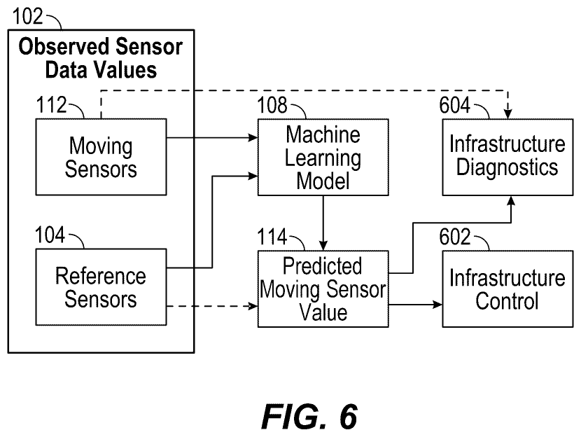

FIG. 6 is a block diagram showing how predicted moving sensor values can be used to adjust infrastructure control, in accordance with embodiments of the present disclosure. As shown in FIG. 6, predicted moving sensor values 114 are made for a time and location of interest. An infrastructure control system 602 reads these sensor values and makes adjustments to infrastructure control accordingly. For example, the amount of light received at a specific location in the grow space can be decomposed into sources of natural and artificial light. The machine learning model 108 can be used to estimate the amount of light from both sources, and the lights are turned off using infrastructure control 602 after a desired threshold.

In some embodiments, the predicted moving sensor values 114 can be used to perform infrastructure diagnostics 604. In such embodiments, the expected sensor value can be compared to what is observed by an infrastructure system. If the observed value greatly deviates from the predicted value, growers can be notified of undefined behavior in the grow space, and adjustments can be made accordingly.

According to various embodiments, the physical environment experienced by a plant is a dominant factor in its health and productivity. However, measuring the environment experienced by the plant in a specific location at regular intervals is difficult to achieve. If the environmental conditions of a grow space are able to be observed at sufficient resolution, both crop varieties and environmental infrastructure can be tuned to increase yield and decrease operating costs.

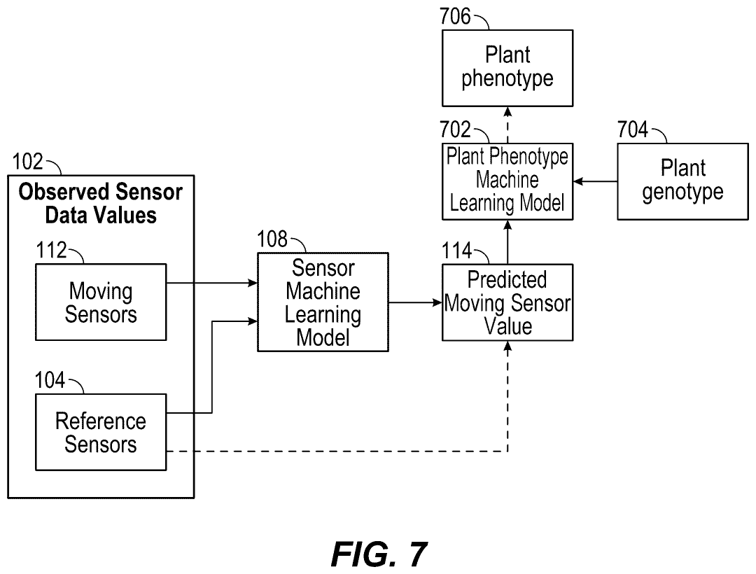

FIG. 7 is a block diagram showing how predicted moving sensor values can be used to adjust different plant variables, in accordance with embodiments of the present disclosure. As shown in FIG. 7, in some embodiments, predicted moving sensor values 114 are made at regular intervals to determine exactly when and where a plant is grown. These predicted sensor values can be aggregated across modalities, effectively gathering all sources of environmental stimuli the plant may have experienced. In some embodiments, another machine learning model 702 can be used to build a function from environmental variables 114 and genetics of that crop 704 to the observed plant phenotype 706. In some embodiments, plant phenotype may refer to yield, but it can also refer to a number of other characteristics of interest to a grower, such as taste, color, morphology, and appearance. The phenotype may also include other molecular characteristics, such as RNA expression, epigenetic DNA changes, chemical composition, DNA organization, protein expression, post-translational modifications, and other molecular traits. In some embodiments, the genetic makeup 704 of the crop may simply be the species or variety type, or may be the DNA sequence of the organism, as measured by an SNP chip, imputed genotype, or base and variant calling from next generation DNA sequencing technologies.

In some embodiments, machine learning model 702 can help decouple the effects of genetics 704 and environment 114 on plant phenotype 706. By understanding and controlling for environmental effects 114 experienced by a plant, the effects of genetics 704 on phenotype 706 can be isolated and subsequently used for targeted plant breeding approaches.

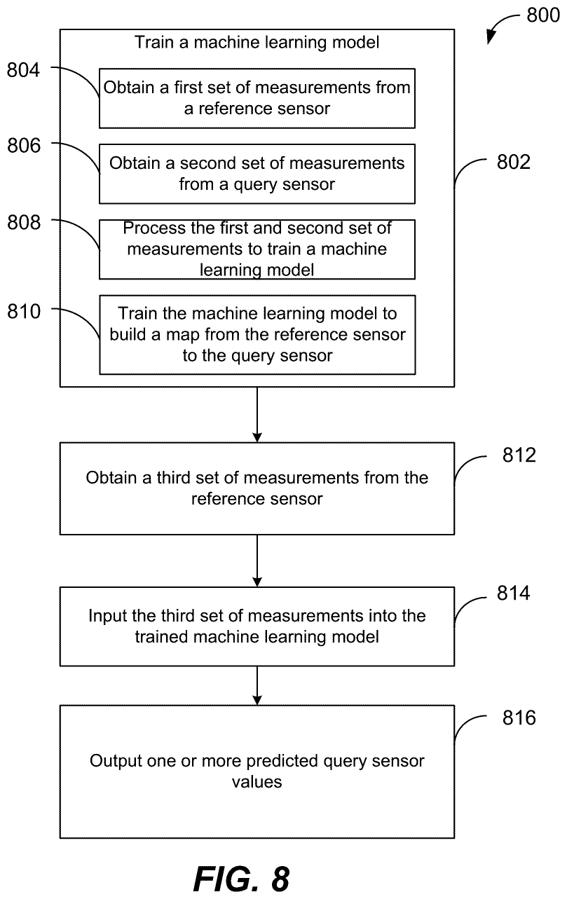

FIG. 8 illustrates a method for predicting grow space sensor query sensor values using a machine learning model, in accordance with embodiments of the present disclosure. Method 800 begins with training (802) a machine learning model. In some embodiments, the training includes obtaining (804) a first set of measurements from a reference sensor. In some embodiments, the training also includes obtaining (806) a second set of measurements from a query sensor. In some embodiments, the training also includes processing (808) the first and second set of measurements to train a machine learning model. In some embodiments, the training lastly includes training (810) the machine learning model to build a map from the reference sensor to the query sensor.

After step 802, method 800 includes obtaining (812) a third set of measurements from the reference sensor. In step 814, the third set of measurements is inputted into the trained machine learning model. In step 816, one or more predicted query sensor values are output.

In some embodiments, the second set of measurements from the query sensor is remotely acquired by a mechanical or robotic apparatus in an environment or grow space. In some embodiments, the predicted query sensor values are used to provide robustness and redundancy in the case of unreliable sensor measurements. In some embodiments, the predicted query sensor values are used to notify changes or disruptions in grow spaces and/or environmental control systems. In some embodiments, predicted query sensor values are used to control environmental control systems. In some embodiments, predicted query sensor values are used to explain variation in plant phenotypes.

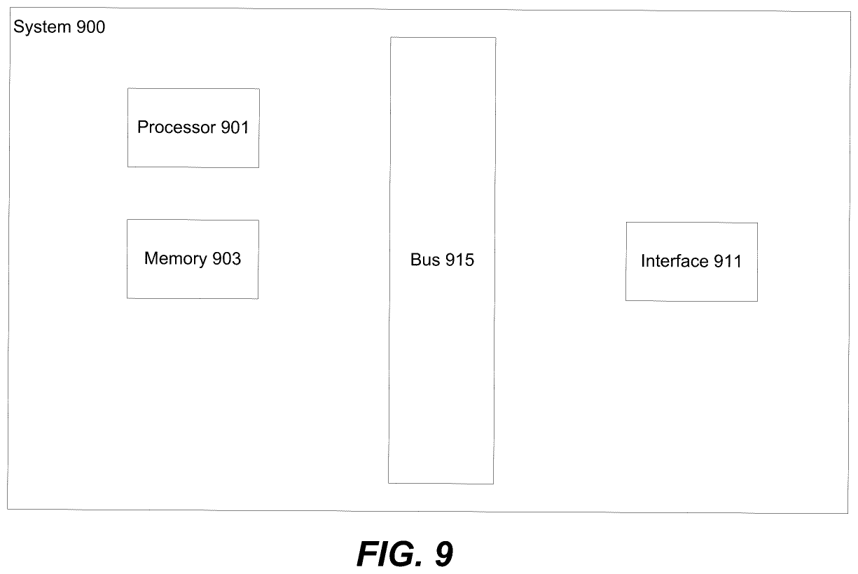

The examples described above present various features that utilize a computer system or a robot that includes a computer. However, embodiments of the present disclosure can include all of, or various combinations of, each of the features described above. FIG. 9 illustrates one example of a computer system, in accordance with embodiments of the present disclosure. According to particular embodiments, a system 900 suitable for implementing particular embodiments of the present disclosure includes a processor 901, a memory 903, an interface 911, and a bus 915 (e.g., a PCI bus or other interconnection fabric). When acting under the control of appropriate software or firmware, the processor 901 is responsible for implementing applications such as an operating system kernel, a containerized storage driver, and one or more applications. Various specially configured devices can also be used in place of a processor 901 or in addition to processor 901. The interface 911 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 900 is a computer system configured to run a control space operating system, as shown herein. In some implementations, one or more of the computer components may be virtualized. For example, a physical server may be configured in a localized or cloud environment. The physical server may implement one or more virtual server environments in which the control space operating system is executed. Although a particular computer system is described, it should be recognized that a variety of alternative configurations are possible. For example, the modules may be implemented on another device connected to the computer system.

In the foregoing specification, the present disclosure has been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure.

What is claimed is:

1. A system comprising:
a reference sensor;
a query sensor;
a processor; and
memory, the memory storing instructions to cause a processor to execute a method, the method comprising:
training a machine learning model, the training comprising:
obtaining a first set of measurements from the reference sensor;
obtaining a second set of measurements from the query sensor;
processing the first and second set of measurements to train a machine learning model; and
training the machine learning model to build a map from the reference sensor to the query sensor;
obtaining a third set of measurements from the reference sensor;
inputting the third set of measurements into the trained machine learning model; and
outputting one or more predicted query sensor values.

2. The system of claim 1, wherein the second set of measurements from the query sensor is remotely acquired by a mechanical or robotic apparatus in an environment or grow space.

3. The system of claim 1, wherein the predicted query sensor values are used to provide robustness and redundancy in the case of unreliable sensor measurements.

4. The system of claim 1, wherein the predicted query sensor values are used to notify changes or disruptions in grow spaces and/or environmental control systems.

5. The system of claim 1, wherein predicted query sensor values are used to control environmental control systems.

6. The system of claim 1, wherein predicted query sensor values are used to explain variation in plant phenotypes.

7. The system of claim 1, wherein the query sensor is a moving sensor configured to sense conditions around a grow space.

8. A grow space comprising:
a reference sensor;
a query sensor;
a processor; and
memory, the memory storing instructions to cause a processor to execute a method, the method comprising:
training a machine learning model, the training comprising:
obtaining a first set of measurements from the reference sensor;
obtaining a second set of measurements from the query sensor;
processing the first and second set of measurements to train a machine learning model; and
training the machine learning model to build a map from the reference sensor to the query sensor;
obtaining a third set of measurements from the reference sensor;
inputting the third set of measurements into the trained machine learning model; and
outputting one or more predicted query sensor values.

9. The grow space of claim 8, wherein the second set of measurements from the query sensor is remotely acquired by a mechanical or robotic apparatus in an environment or grow space.

10. The grow space of claim 8, wherein the predicted query sensor values are used to provide robustness and redundancy in the case of unreliable sensor measurements.

11. The grow space of claim 8, wherein the predicted query sensor values are used to notify changes or disruptions in grow spaces and/or environmental control systems.

12. The grow space of claim 8, wherein predicted query sensor values are used to control environmental control systems.

13. The grow space of claim 8, wherein predicted query sensor values are used to explain variation in plant phenotypes.

14. The grow space of claim 8, wherein the query sensor is a moving sensor configured to sense conditions around a grow space.

15. A method for predicting grow space sensor query sensor values using a machine learning model, the method comprising:
training a machine learning model, the training comprising:
obtaining a first set of measurements from a reference sensor;
obtaining a second set of measurements from a query sensor;
processing the first and second set of measurements to train a machine learning model; and
training the machine learning model to build a map from the reference sensor to the query sensor;
obtaining a third set of measurements from the reference sensor;
inputting the third set of measurements into the trained machine learning model; and
outputting one or more predicted query sensor values.

16. The method of claim 15, wherein the second set of measurements from the query sensor is remotely acquired by a mechanical or robotic apparatus in an environment or grow space.

17. The method of claim 15, wherein the predicted query sensor values are used to provide robustness and redundancy in the case of unreliable sensor measurements.

18. The method of claim 15, wherein the predicted query sensor values are used to notify changes or disruptions in grow spaces and/or environmental control systems.

19. The method of claim 15, wherein predicted query sensor values are used to control environmental control systems.

20. The method of claim 15, wherein predicted query sensor values are used to explain variation in plant phenotypes.
